(19) United States
(12) Patent Application Publication
(10) Pub. No.: US 2006/0052500 A1
(43) Pub. Date: Mar. 9, 2006

(54) Rubber eraser and method of fabrication

(76) Inventor: Fu-Yuan Cheng, Taiping City (TW)

Correspondence Address: LEONG C LEI, PMB # 1008, 1867 YGNACIO VALLEY ROAD, WALNUT CREEK, CA, 94598, US

(21) Appl. No.: 10/933,241

(22) Filed: Sep. 3, 2004

(51) Int. Cl. C08K 5/10; C08K 5/09; C08K 3/26

(52) U.S. Cl. 524/315; 524/394; 524/425

(57) ABSTRACT

A rubber eraser and method of fabrication is disclosed. The mixture comprising a rubber eraser composition comprising non-crosslinked polymer, plasticizer, stabilizer, thixotropic filler and pigment; wherein the non-crosslinked polymer is a basic material ranges from 20% to 40% by weight; the plasticizer ranges from 30% to 50% by weight; the stabilizer ranges about from 2% to 5% by weight; the thixotropic filler ranges about from 20% to 40% by weight for the rubber eraser mixture to form into a soft clay-like mixture; and pigment ranges from about 0.5% to 1% for coloration of the eraser. The method includes the steps of heating the eraser mixture for at room to 50-70 degree C.; mixing the mixtures and kneading cutting or pressing to form into a desired shape; and placing the obtained product into an oven or hot air device at temperature 120° C. to 130° C.

### BACKGROUND OF THE INVENTION

(a) Technical Field of the Invention

The present invention relates to rubber eraser and method of fabrication thereof, and in particular, rubber eraser mixture which is a soft clay-like mixture can be made into eraser of various shapes.

(b) Brief Description of the Prior Art

Rubber eraser is used to erase pencil marks. Taiwanese Patent Publication No. 330208 and Publication No. 521047 disclose rubber eraser composition including styrene elastomer, rubber or the composition thereof, polyethene, softening oil, polyethene elastomer, inorganic filler, dyes or the mixtures thereof. The rubber eraser composition does not contain PVC, which can be fabricated by ejection molding or extrusion. The rubber eraser has an erasing function.

This type of eraser is obtained by mixing of raw material to form fluid mixture and proceeding to molding to form various shape in a mold, and cooling the mold to retrieve the eraser. This type of eraser is only be able to make using mechanical devices and at mass production. This method does not fulfill the needs of the user.

Taiwanese Patent Publication No. 256810, entitled “A Method of Fabricating Eraser” discloses using a mold for eraser mixture; placing the mixture into the mold; introducing 100 degree C. of boiling water and boiling for 3-5 minutes to cure the mixture; withdrawing the eraser blank after the mold has been cool. This method requires a mold for the eraser and a heating to 100 degree C. is needed. This is not appropriate for children to DIY fabrication. Thus, in order to improve the eraser mixture so as to allow children to fabricate rubber eraser, the inventor has developed a rubber eraser which can be cured, and the method of fabricating the same.

### SUMMARY OF THE INVENTION

Accordingly, it is an object of the present invention is to provide a rubber eraser and method of fabrication, wherein the composition includes non-crosslinked polymers, plasticizer, stabilizer, thixotropic filler and dyes; wherein the non-crosslinked polymer is a basic material ranges from 20% to 40% by weight; the plasticizer ranges from 30% to 50% by weight; the stabilizer ranges about from 2% to 5% by weight; the thixotropic filler ranges about from 20% to 40% by weight for the rubber eraser mixture to form into a soft clay-like mixture; and pigment ranges from about 0.5% to 1% for coloration of the eraser.

In accordance with the present invention, the raw material mixtures are heated appropriately with stirring so that the raw material is formed into a stable, non-sticky, plasticible soft clay-like rubber eraser mixture. The user can make the rubber eraser into any shapes as desired.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention relates to rubber eraser which can be cured by heating after a plasticizing step, and the method of fabrication. The composition of the rubber eraser comprises non-crosslinked polymers plasticizer, stabilizer, thixotropic filler and pigment, wherein the non-crosslinked polymer is the base material and ranging from 20% to 40% by weight, includes one of PVC, PVOH, polyamine ester, epoxy, resin or the mixtures thereof. The plasticizer is about 30 to 50% by weight and includes DOP, DOA, DINP, glyceric oil, wax, epoxy soya oil, or the mixture thereof.

The stabilizer is about 2% to 5%, and the stabilizer includes zinc stearate, calcium stearate, Nitrate Stearate, Organic TNPP liquid Ba—Zn, liquid Ca—Zn or the mixture thereof. The thixotropic filler is about 20 to 40% by weight and half of filler is calcium carbonate and the other half is talc, clay, AlOH₃, Vapor phase Silicon dioxide, kaolin, semi-maltose, or the mixtures thereof for use to cause the rubber eraser mixture a soft clay-like. The pigment is about 0.5% to 1%, and the pigment is color powder, dyes, fluorescent powder, pearl powder, aluminum powder, wood powder or the mixture thereof for coloration of the rubber eraser.

After the above raw materials are mixed, a stirrer or a kneading machine is used to elevate the temperature to 50 to 70 degree C. to cause the plasticizer to penetrate to loose the non-crosslinked polymer, and there is no excessive plasticizer and to improve the binding force of the non-crosslinked polymer and the thixotropic filler. Thus, a stable, non-sticky and plasticible soft clay-like rubber eraser raw material mixture is obtained. If the mixture has not been stirred to elevate the temperature, the mixture shall be sticky, and the mixture could be too soft and too hard which cannot be difficult to form into various shape.

In the present invention, after the above raw material are heated and mixed, it is formed into a soft clay-like rubber eraser mixture facilitating kneading.

The rubber eraser mixtures can be made by user by kneading, cutting, pressing on other method to form into desired shape. The formed product can be placed in a oven or hot air device at a temperature of 120 degree C. to 130 degree C. for 10 minutes (if the eraser has a thickness of 1 cm, the heating time has to be changed depending on the thickness of the eraser). Thus, eraser of various shape can be obtained.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A rubber eraser composition comprising non-crosslinked polymer, plasticizer, stabilizer, thixotropic filler and pigment; wherein the non-crosslinked polymer is a basic material ranges from 20% to 40% by weight;
the plasticizer ranges from 30% to 50% by weight;
the stabilizer ranges about from 2% to 5% by weight;
the thixotropic filler ranges about from 20% to 40% by weight for the rubber eraser mixture to form into a soft clay-like mixture; and
pigment ranges from about 0.5% to 1% for coloration of the eraser.

2. The composition of claim 1, wherein the non-crosslinked polymer includes PVC, PVA, polyamide ester, epoxy resin or the mixture thereof.

3. The composition of claim 1, wherein the plasticizer includes DOP, DOA, DINP, epoxy soya oil, glyceride oil, wax oil or the mixture thereof.

4. The composition of claim 1, wherein the stabilizer includes zinc stearate, calcium stearate, stearate, TNPP, liquid Ba—Zn, liquid Ca—Zn or the mixture thereof.

5. The composition of claim 1, wherein the thixotropic filler includes one half of the weight being calcium carbonate, and the other half by weight including talc, kaolin, AlOH₃; vapor phase silicon dioxide, kaolin and the mixture thereof.

6. The composition of claim 1, wherein the pigment includes color powder, dyes, fluorescent powder, pearl powder, aluminum powder, wood powder or the mixture thereof.

7. The composition of claim 1, wherein the mixture is mixed by means of a stirrer or kneading machine from room temperature to 50-70 degree to proceed mixing and heating.

8. A method of fabricating rubber eraser mixture comprising the steps of:
heating the eraser mixture for at room to 50-70 degree C.;
mixing the mixtures and kneading cutting or pressing to form into a desired shape; and
placing the obtained product into an oven or hot air device at temperature 120° C. to 130° C.
